(19) United States
(12) Patent Application Publication
(10) Pub. No.: US 2026/0239134 A1
(43) Pub. Date: Aug. 13, 2026

(54) Method And Apparatus For Reducing Cell Switch Delay In Layer-1 Or Layer-2 Triggered Mobility

(71) Applicant: MediaTek Singapore Pte. Ltd., Singapore (SG)

(72) Inventors: Miao Wang, Beijing (CN); Tsang-Wei Yu, Hsinchu City (TW)

(73) Assignee: MediaTek Singapore Pte. Ltd., Singapore (SG)

(21) Appl. No.: 19/471,393

(22) PCT Filed: May 16, 2024
(86) PCT No.: PCT/CN2024/093605

§ 371 Date: Oct. 1, 2025

(30) Foreign Application Priority Data
Jul. 21, 2023 (WO) PCT/CN2023/108583

(51) Int. Cl. H04W 36/04; H04B 7/06; H04B 17/318; H04W 36/00; H04W 56/00; H04W 72/231; H04W 74/0833; H04W 80/02

(52) U.S. Cl. CPC H04W 36/04; H04B 7/06968; H04B 17/328; H04W 36/0016; H04W 56/0015; H04W 72/231; H04W 74/0833; H04W 80/02

(57) ABSTRACT

Examples pertaining to an apparatus (e.g., a user equipment) for reducing a cell switch delay in layer-1 (L1) or layer-2 (L2) triggered mobility (LTM) are described. The apparatus receives an LTM cell switch command from a serving cell. The apparatus determines whether a first time or frequency (T/F) tracking on a target cell is activated before the LTM cell switch command. The apparatus determines whether a L1-reference signal received power (L1-RSRP) measurement period is not larger than a predetermined value. The apparatus determines not to perform a second T/F tracking on the target cell before transmitting a first uplink (UL) message on the target cell in an event that at least one condition is met. The at least one condition includes that the first T/F tracking on the target cell is activated before the LTM cell switch command and the L1-RSRP measurement period is not larger than the predetermined value.

### CROSS REFERENCE TO RELATED PATENT APPLICATION(S)

The present disclosure is part of a non-provisional application claiming the priority benefit of PCT Application No. PCT/CN2023/108583, filed 21 Jul. 2023, the content of which herein being incorporated by reference in its entirety.

### TECHNICAL FIELD

The present disclosure is generally related to mobile communications and, more particularly, to reducing a cell switch delay in layer-1 (L1) or layer-2 (L2) triggered mobility (LTM).

### BACKGROUND

Unless otherwise indicated herein, approaches described in this section are not prior art to the claims listed below and are not admitted as prior art by inclusion in this section.

In mobile communications, handover refers a process of transferring an ongoing communication session of a user equipment (UE) from one cell to another in connected state, such that seamless connectivity and continuity of service for the user can be ensured, especially when the user is on the move. In legacy handover (e.g., a type of cell switch) specified in 3^{rd} Generation Partnership Project (3GPP) Release 17, a serving cell switch is triggered by layer-3 (L3) measurements with radio resource control (RRC) signaling for switching from a serving cell to a target cell. This L3-based mobility involves reconfiguration of upper layers (e.g., RRC layer and/or packet data convergence protocol (PDCP) layer) and resetting of lower layers (e.g., medium access control (MAC) layer and/or physical (PHY) layer), which inevitably leads to long latency, large signaling overhead, and long interruption time. Advanced to Release 18, a lower-layer-triggered mobility (or called LTM) is introduced to enable the cell switch procedure via L1 or L2 signaling, which can keep configuration of the upper layers and/or minimize changes of configuration of the lower layers for reducing latency during the cell switch procedure.

While applying the LTM in a fifth generation (5G) New Radio (NR) system, a base station (BS) may trigger the cell switch procedure to change a serving cell of the UE via an LTM cell switch command, and the UE may be switched from the serving cell to a target cell with a candidate configuration that is previously prepared and provided to the UE. Upon receiving the LTM cell switch command, the UE may need to perform operations, e.g., LTM cell switch command processing/decoding, LTM processing for RRC signaling, LTM processing and a time or frequency (T/F) tracking, when switching to the target cell. However, the above operations will cause a cell switch delay in the UE's ongoing communication session, which may be detrimental to the user experience.

Therefore, there is a need to provide solutions for improving the cell switch procedure to reduce the cell switch delay in LTM.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose solutions or schemes that address the aforementioned issue pertaining to the cell switch delay in LTM. It is believed that the above-described issue would be avoided or otherwise alleviated by implementing one or more of the proposed schemes described herein.

In one aspect, a method may involve a processor of an apparatus receiving an LTM cell switch command from a serving cell. In response, the method may involve the processor determining whether a first T/F tracking on a target cell is activated before the LTM cell switch command. The method may also involve the processor determining whether an L1-RSRP measurement period is not larger than a predetermined value. As that, the method may involve the processor determining not to perform a second T/F tracking on the target cell before transmitting a first uplink (UL) message on the target cell in an event that at least one condition is met. The at least one condition may include that the first T/F tracking on the target cell is activated before the LTM cell switch command and the L1-RSRP measurement period is not larger than the predetermined value.

In another aspect, an apparatus may include a transceiver which, during operation, communicates with a serving cell and a target cell of a network. The apparatus may include a processor communicatively coupled to the transceiver. The processor may receive, via the transceiver, an LTM cell switch command from the serving cell. In response, the processor may determine whether a first T/F tracking on the target cell is activated before the LTM cell switch command. The processor may also determine whether an L1-RSRP measurement period is not larger than a predetermined value. As that, the processor may determine not to perform a second T/F tracking on the target cell before transmitting a first UL message on the target cell in an event that at least one condition is met. The at least one condition may include that the first T/F tracking on the target cell is activated before the LTM cell switch command and the L1-RSRP measurement period is not larger than the predetermined value.

It is noteworthy that, although description provided herein may be in the context of certain radio access technologies, networks and network topologies such as NR system, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network system in accordance with an implementation of the present disclosure.

FIG. 2A is a diagram of an example deployment scenario for intra-DU inter-cell beam management in accordance with an implementation of the present disclosure.

FIG. 2B is a diagram of an example deployment scenario for inter-DU inter-cell beam management in accordance with an implementation of the present disclosure.

FIG. 3 is a diagram based on a first scheme for LTM in accordance with an implementation of the present disclosure.

FIG. 4 is a diagram based on a second scheme for LTM in accordance with an implementation of the present disclosure.

FIG. 5 illustrates another example communication system having at least an example communication apparatus and an example network apparatus in accordance with an implementation of the present disclosure.

FIG. 6 illustrates an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reducing a cell switch delay in LTM. According to the present disclosure, a number of possible solutions may be implemented separately or jointly. That is, although these possible solutions may be described below separately, two or more of these possible solutions may be implemented in one combination or another.

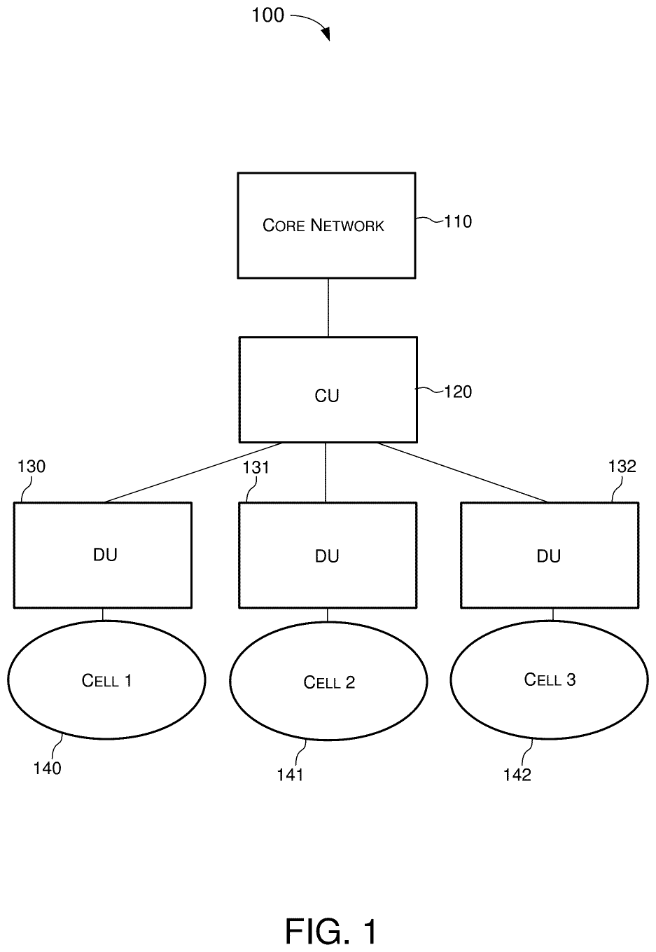

FIG. 1 illustrates an example mobile communication network 100 in accordance with an implementation of the present disclosure. As shown in FIG. 1, the mobile communication network 100 supports various wireless communication services and may be functionally operated with different protocol split options among at least a core network 110 and a plurality of BSs, e.g., evolved NodeBs (eNBs), next generation NodeBs (gNBs), or transmission and reception points (TRPs). In some implementations, the plurality of BSs may be gNBs implemented as a central unit (CU) 120 and distributed units (DUs) 130-132 associated with serving coverages/cells (e.g., Cell 1, Cell 2 and Cell 3). In some implementations, service data application protocol (SDAP) and packet data convergence protocol (PDCP) layers may be located in the CU 120, and radio link control (RLC), medium access control (MAC) and physical (PHY) layers may be located in the DUs 130-132.

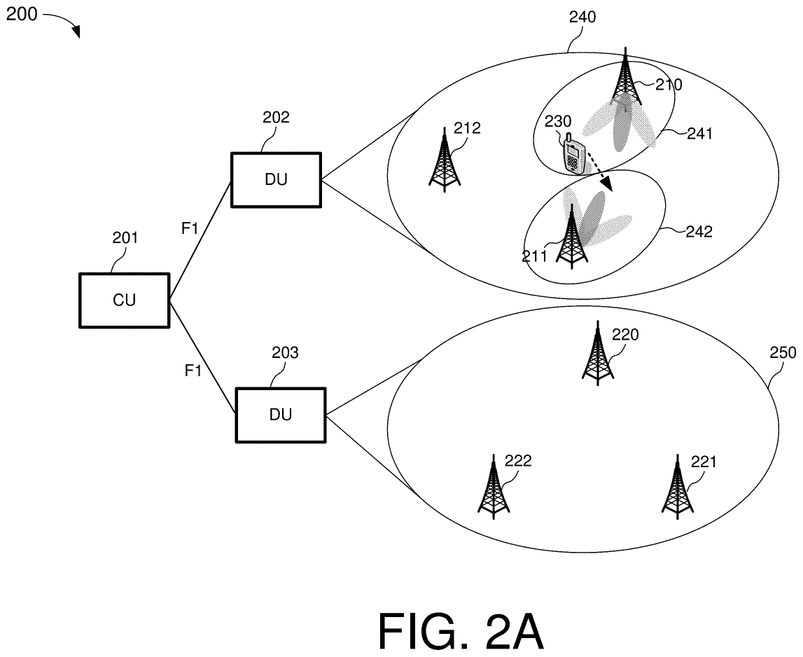

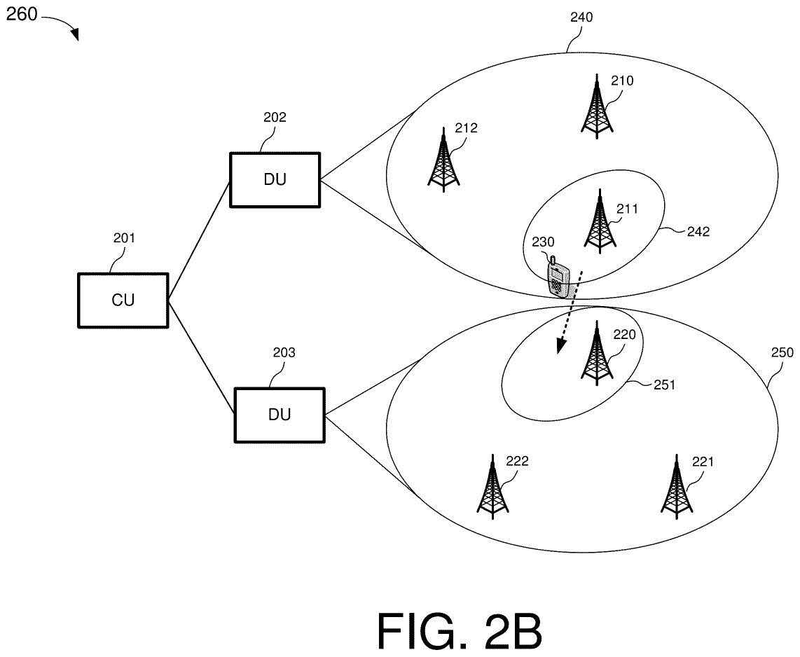

FIG. 2A illustrates an example deployment scenario 200 for intra-DU inter-cell beam management in accordance with an implementation of the present disclosure. As shown in FIG. 2A, a CU 201 connects to two DUs 202 and 203 via F1 interface, and two DUs are connected to multiple radio units (RUs), respectively. For example, the DU 202 connects to RUs 210-212 and the DU 203 connects to RUs 220-222. Each RU may correspond to one cell that can independently provide wireless communication service within a coverage of the cell, and the DU connecting to at least one RU(s) may correspond to an integrated coverage/cell. For example, an integrated coverage/cell 240 corresponds to the DU 202 and an integrated coverage/cell 250 corresponds to the DU 203.

As shown in FIG. 2A, a UE 230 is moving from an edge of one cell (e.g., cell 241) to another cell (e.g., cell 242) within the same DU (e.g., DU 202), and the two cells share a common protocol stack. An intra-DU inter-cell beam management can be applied in the deployment scenario 200 to replace the legacy handover process, so as to reduce the interruption and improve the throughput and handover reliability in terms of handover failure rate of UE. In some implementations, single protocol stack at the UE side (i.e., common RLC/MAC) may be used to handle L1 or L2 inter-cell beam management with mobility.

FIG. 2B illustrates an example deployment scenario 260 for inter-DU inter-cell beam management in accordance with an implementation of the present disclosure. Similar to the deployment scenario 200 in FIG. 2A, the deployment scenario 260 in FIG. 2B includes the CU 201, the two DUs 202 and 203, multiple RUs 210-212 and 220-222, and the integrated coverages/cells 240 and 250. The difference is that the UE 230 is moving from the edge of one cell (e.g., cell 242) to another cell (e.g., cell 251), where the cells 242 and 251 corresponding to different DUs (e.g., cell 242 corresponding to DU 202 and cell 251 corresponding to DU 203) and share a common CU (e.g., CU 201). As that, the low layer (e.g., RLC and MAC) user plane may be different in two DUs and the high layer (e.g., PDCP) may remain the same, and an inter-DU inter-cell beam management can be applied for the deployment scenario 260 to replace the legacy handover process, so as to reduce the interruption and improve the throughput and handover reliability in terms of handover failure rate of UE. In some implementations, single protocol stack at the UE side (i.e., common RLC/MAC) may be used to handle L1 or L2 inter-cell beam management with mobility. In some implementations, dual protocol stacks at the UE side (i.e., separate RLC/MAC) may be used to handle L1 or L2 inter-cell beam management with mobility.

In Release 17, a handover (e.g., a type of cell switch) is triggered by L3 measurements with RRC signaling for switching from a serving cell to a target cell. Advanced to Release 18, the LTM is newly introduced to enable the cell switch procedure via L1 or L2 signaling (i.e., lower layer signaling), which can effectively reduce latency, overhead and interruption time during the cell switch procedure. In some embodiments, the LTM may support at least one of the intra-DU inter-cell beam management shown in FIG. 2A, the inter-DU inter-cell beam management shown in FIG. 2B, and an inter-CU beam management. As that, during the LTM, the user plane may be continuously utilized on the target cell without being reset (i.e., being intra-DU), so as to avoid data loss and additional delay of data recovery.

In some implementations, while introducing the LTM in the NR system, the UE may be configured with at least one candidate cell configuration(s) to perform measurement(s) on the candidate cell(s) if a serving cell (or its BS) initiates the cell switch procedure. After the UE reports the corresponding measurement(s) to the serving cell, the serving cell may indicate to the UE to perform the cell switch procedure for switching to one target cell via an LTM cell switch command (e.g., a MAC CE or other signaling). During measuring on the at least one candidate cell(s), the UE may perform a pre-tracking (e.g., first T/F tracking) via a reference signal (RS) to synchronize with the candidate cell(s). Specifically, the RS may include synchronization signal and physical broadcast channel (PBCH) block (SSB) or tracking reference signal (TRS) from the target cell. In some implementations, the first T/F tracking may be activated by a transmission configuration indicator (TCI) state activation command (e.g., a MAC CE). If a TCI state activation command is received, the UE may periodically perform the first T/F tracking on the target cell.

In some implementations, upon receiving the LTM cell switch command (e.g., via a MAC CE or other signaling) from the serving cell, the UE may perform operations including LTM cell switch command processing/decoding, LTM processing for RRC signaling, LTM processing, and another T/F tracking (e.g., second T/F tracking or called fine tracking). The above operations may cause additional delay, specified as a cell switch delay, before the UE completes the cell switch procedure to successfully switch from the serving cell to the target cell.

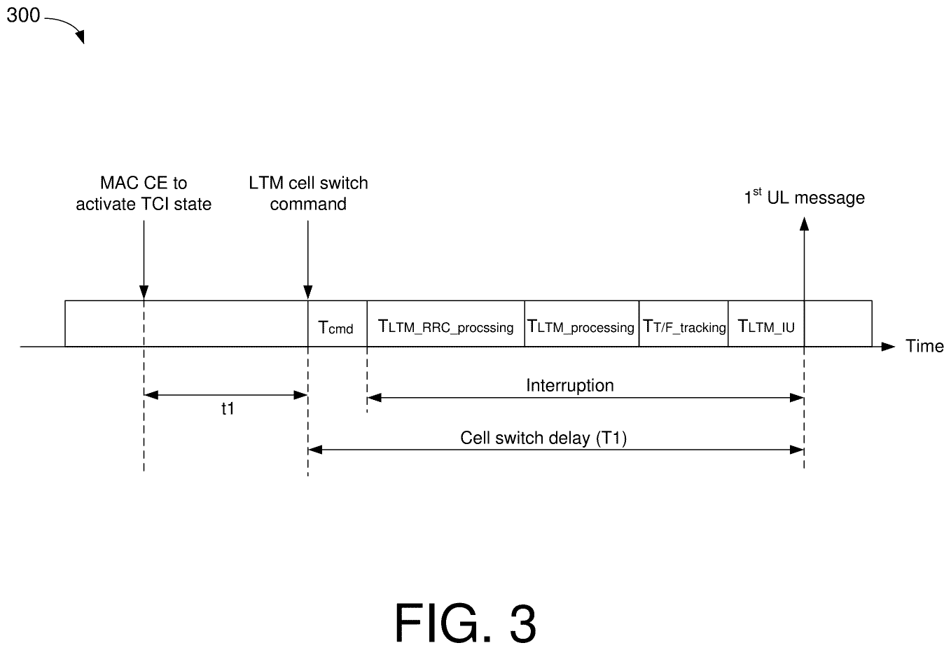

FIG. 3 illustrates an example scenario 300 of a cell switch delay in LTM in accordance with an implementation of the present disclosure. As shown in FIG. 3, in some implementations, the UE may sequentially receive, from the serving cell, a MAC CE, which is used for activating a TCI state of the target cell, as well as receiving an LTM cell switch command (e.g., via another MAC CE) indicating the cell switch procedure. In some implementations, the above MAC CE received by the UE for activating the first T/F tracking, the TCI state of the target cell and/or the LTM cell switch command may be separately transmitted or adaptively integrated for different requirements, which is not limited hereinafter. Next, in response to receiving the LTM cell switch command, the UE may perform the above operations corresponding to a cell switch delay (denoted as T1), which may include an LTM cell switch command processing period T_{cmd}, an RRC signaling processing time T_{LTM_RRC_processing}, an LTM processing period T_{LTM_processing} (L1/L2/L3 processing, including L2 and/or L3 reconfiguration, and/or RF retuning, and/or baseband retuning, and/or security update, etc.), a second T/F tracking period T_{T/F_tracking}, and the time waiting for the first UL occasion T_{LTM_IU}, where the second T/F tracking is also utilized to synchronize with the target cell in DL and/or UL transmission. After processing the above operations and successfully switching to the target cell, the UE may perform a first UL message/transmission (e.g., physical random access channel (PRACH) and/or physical uplink shared channel (PUSCH)) on the target cell.

Considering the above operations, since the first T/F tracking has been performed on the target cell and the second T/F tracking is also performed on the target cell for the same function/purpose (e.g., synchronizing on the target cell in DL transmission), there may be a redundant processing in sequentially performing both the first T/F tracking and the second T/F tracking under certain conditions. In order to reduce the cell switch delay, some proposed schemes are introduced below to adaptively skip redundant T/F tracking for improvement.

Under a first proposed scheme of the present disclosure, upon receiving the LTM cell switch command from a serving cell, the UE may perform two determinations, including determining whether a first T/F tracking (i.e., the pre-tracking) on a target cell is activated before receiving the LTM cell switch command (denoted as determination D1-1), and determining whether an L1-RSRP measurement period is not larger than a predetermined value (denoted as determination D1-2). Specifically, the predetermined value may be 160 millisecond (ms) or other integral values, as specified in Release 18 or other versions of 3GPP specification, complying with different requirements.

If the UE determines that both the two determinations D1-1 and D1-2 are valid/true (i.e., the first T/F tracking on the target cell is activated before receiving the LTM cell switch command as well as the L1-RSRP measurement period is not larger than the predetermined value), the UE may determine not to perform a second T/F tracking (i.e., the fine tracking) on the target cell before transmitting a first UL message, e.g., PRACH and/or PUSCH, on the target cell. That is to say, the UE may directly utilize the information (e.g., DL synchronization information) obtained from the first T/F tracking on the target cell during the cell switch procedure and skip the second T/F tracking on the target cell, which may effectively reduce additional processing time and shorten the cell switch delay. Certainly, more determinations other than the determinations D1-1 and D1-2 may be applied for the UE to determine whether to perform the second T/F tracking on the target cell before transmitting the first UL message, which is not restricted hereinafter.

Alternatively, if the UE determines that at least one of the two determinations D1-1 and D1-2 is not valid/true (i.e., the first T/F tracking on the target cell is not activated before receiving the LTM cell switch command and/or the L1-RSRP measurement period is larger than the predetermined value), the UE may determine to perform the second T/F tracking on the target cell before transmitting the first UL message (e.g., PRACH and/or PUSCH) on the target cell. That is to say, the UE still needs to perform the second T/F tracking on the target cell since the information (e.g., DL synchronization information) associated with the target cell may be out-of-date and should be re-obtained/updated before switching to the target cell.

Under a second proposed scheme of the present disclosure, upon receiving the LTM cell switch command from a serving cell, the UE may perform three determinations, including determining whether the TCI state of the target cell indicated in the LTM cell switch command is in an active TCI state list (denoted as determination D2-1), determining whether the time difference (denoted as t1) between receiving the MAC CE activating the target TCI state and the LTM cell switch command is at least a duration (denoted as determination D2-2) which is a period X associated with processing the first T/F tracking and allows the UE to completely finish operations of the first T/F tracking (i.e., the duration X is long enough for the UE to perform the first T/F tracking), and determining whether an L1-RSRP measurement period is not larger than a predetermined value (denoted as determination D2-3). Specifically, the predetermined value may be 160 ms or other integral values, as specified in Release 18 or other versions of 3GPP specification, complying with different requirements.

If the UE determines that all of the three determinations D2-1, D2-2, and D2-3 are valid/true (i.e., the target TCI state of the target cell indicated in the LTM cell switch command is in the active TCI state list, the time difference t1 is at least the duration X (i.e., t1 is equal to or greater than X), and the L1-RSRP measurement period is not larger than the predetermined value), the UE may determine not to perform the second T/F tracking on the target cell before transmitting the first UL message (e.g., PRACH and/or PUSCH) on the target cell. Certainly, more determinations other than the determinations D2-1, D2-2 and D2-3 may be applied for the UE to determine whether to perform the second T/F tracking on the target cell before transmitting the first UL message, which is not restricted hereinafter. For example, an additional determination, in which the UE determines whether the time difference t1 is not larger than 160 ms, may be adaptively incorporated into the second scheme, such that the determinations being valid/true would indicate X<t1<160 ms.

Alternatively, if the UE determines that at least one of the three determinations D2-1, D2-2, and D2-3 is not valid (i.e., the target TCI state of the target cell indicated in the LTM cell switch command is not in the active TCI state list, the time difference t1 is not at least the duration X, and/or the L1-RSRP measurement period is larger than the predetermined value), the UE may determine to perform the second T/F tracking on the target cell before transmitting the first UL message (e.g., PRACH and/or PUSCH) on the target cell, such that the UE may timely update/obtain the information (e.g., DL synchronization information) associated with the target cell before transmitting the first UL message (e.g., PRACH and/or PUSCH) on the target cell.

Certainly, the above sequences and/or combinations associated with the determinations D1-1 and D1-2 under the first proposed scheme and the determinations D2-1, D2-2, and D2-3 under the second proposed scheme may be adaptively adjusted to comply with different requirements/capabilities of the NR system or the UE, which is not restricted hereinafter. Also, other determination(s) may be adaptively applied into the first proposed scheme and/or the second proposed scheme based on different requirements/capabilities of the NR system or the UE, which is not restricted hereinafter.

As shown in FIG. 3, while determining that the time difference t1 is not at least the duration X (i.e., t1 is less than the duration X derived from the formula 1), the UE may determine to perform the second T/F tracking on the target cell before transmitting the first UL message (e.g., PRACH and/or PUSCH) on the target cell.

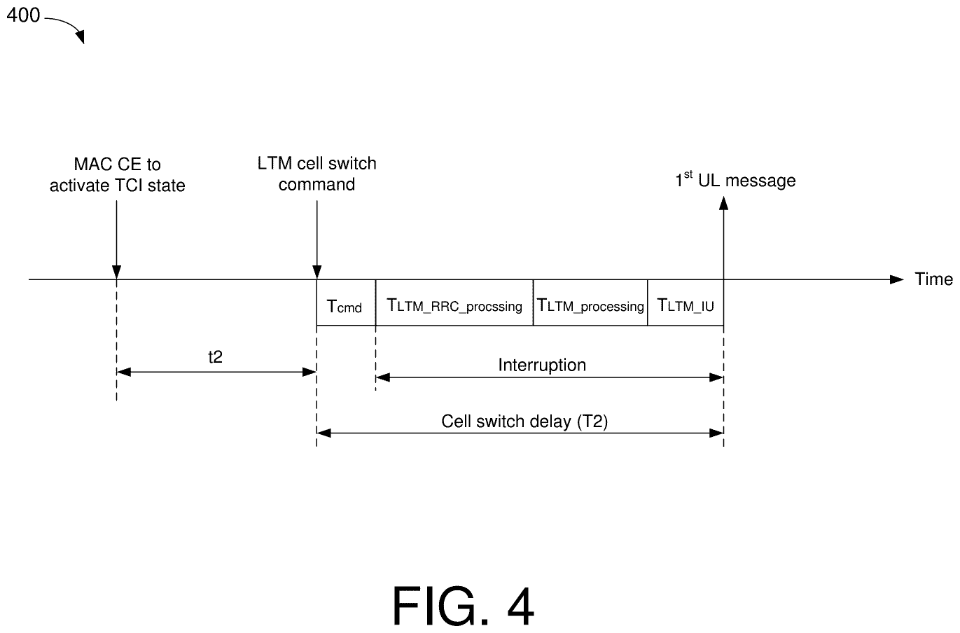

FIG. 4 illustrates an example scenario 400 of a cell switch delay in LTM in accordance with an implementation of the present disclosure. Scenario 400 is similar to scenario 300, except that scenario 400 is exemplary demonstrated under the condition that the UE determines not to perform the second T/F tracking on the target cell before transmitting the first UL message (e.g., PRACH and/or PUSCH) on the target cell. Specifically, if the UE applies one of the above first, second, and third proposed schemes to adaptively skip the second T/F tracking during the cell switch procedure triggered by the LTM cell switch command, the UE may spend, during the cell switch procedure, another cell switch delay T2 including an LTM cell switch command processing period T_{cmd}, an RRC signaling processing time T_{LTM_RRC_processing}, an LTM processing period T_{LTM_processing} (i.e., L1/L2/L3 processing, including L2 and/or L3 reconfiguration, and/or RF retuning, and/or baseband retuning, and/or security update, etc.), a second T/F tracking period T_{T/F_tracking}, and the time waiting for the first UL occasion T_{LTM_IU}, where the cell switch delay T2 is clearly shorter than the cell switch delay T1 for reducing the second T/F tracking period T_{T/F_tracking}.

In some implementations, the LTM in the NR system may be implemented by a random access channel (RACH)-based cell switch procedure or a RACH-less cell switch procedure while applying the above first, second, and third proposed schemes. Specifically, in one example for the RACH-based cell switch procedure, before transmitting the first UL message (i.e., PRACH) on the target cell, the UE may transmit a PRACH preamble to the target cell. Next, the UE may receive a random access response (RAR) from the target cell, where the RAR may include an UL grant for transmitting the first UL message on the target cell. In this way, if the UE determines to perform the second T/F tracking during the cell switch procedure, the BS may exclude the UE from RA resource allocation, i.e., more RA resources will be available to be allocated to other UE(s) in the same serving cell.

In one example for the RACH-less cell switch procedure, before transmitting the first UL message (i.e., PUSCH) on the target cell, PRACH on the target cell is not needed and the UE may only receive a downlink control information (DCI) from the target cell for scheduling the transmission of the first UL message on the target cell. In this way, the network may determine when to transmit the DCI to the UE based on whether the UE performs or skips the second T/F tracking. For example, if the UE determines not to perform the second T/F tracking, the BS may transmit the DCI to the UE earlier, such that the UE may transmit the first UL message on the target cell as soon as possible.

In view of the above determinations (e.g., D1-D3) while applying the LTM in the NR system based on RACH-based/RACH-less cell switch procedure, since the UE may adaptively determine not to perform the second T/F tracking (i.e., the fine tracking) in an event that the first T/F tracking (i.e., the pre-tracking) has been performed with applicable/fresh DL synchronization information of the target cell, the cell switch delay can be effectively shortened to reduce latency, signaling overhead, and interruption time during the cell switch procedure.

### Illustrative Implementations

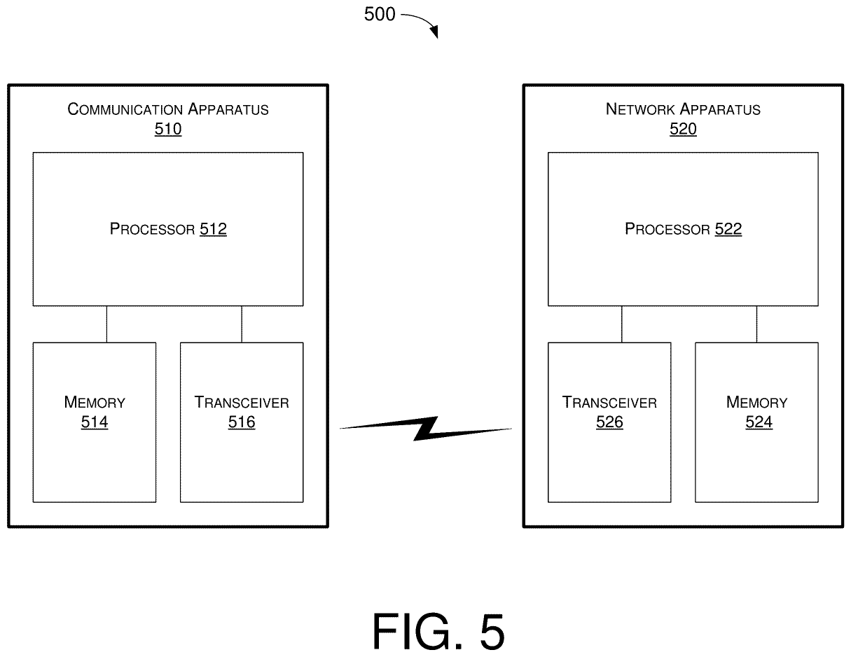

FIG. 5 illustrates an example communication system 500 having at least an example communication apparatus 510 and an example network apparatus 520 in accordance with an implementation of the present disclosure. Each of apparatus 510 and apparatus 520 may perform various functions to implement schemes, techniques, processes and methods described herein pertaining to reducing a cell switch delay in LTM, including the various schemes described above with respect to various proposed designs, concepts, schemes, systems and methods described above, including network system 100, as well as processes described below.

Each of apparatus 510 and apparatus 520 may be a part of an electronic apparatus, which may be a network apparatus or a UE (e.g., UE 230), such as a portable or mobile apparatus, a wearable apparatus, a vehicular device or a vehicle, a wireless communication apparatus or a computing apparatus. For instance, each of apparatus 510 and apparatus 520 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in an eNB in an LTE, LTE-Advanced or LTE-Advanced Pro network or in a gNB, a satellite, a repeater or TRP in a 5G network, an NR network or an IoT network.

In some implementations, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 510 and apparatus 520 may be implemented in or as a network apparatus or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to reducing a cell switch delay in LTM in accordance with various implementations of the present disclosure.

In some implementations, apparatus 510 may also include a transceiver 516 coupled to processor 512. Transceiver 516 may be capable of wirelessly transmitting and receiving data. In some implementations, transceiver 516 may be capable of wirelessly communicating with different types of wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 514 and memory 524 may include a UICC.

Each of apparatus 510 and apparatus 520 may be a communication entity capable of communicating with each other using various proposed schemes in accordance with the present disclosure. For illustrative purposes and without limitation, a description of capabilities of apparatus 510, as a UE (e.g., UE 230) and/or a network node (e.g., RUs 210-212) of a wireless network, is provided below.

Under certain proposed schemes in accordance with the present disclosure with respect to reducing the cell switch delay in LTM, processor 512 of an apparatus 510, implemented in or as UE 230, may receive, via transceiver 516, an LTM cell switch command from a serving cell. Additionally, processor 512 may determine whether a first T/F tracking on a target cell is activated before the LTM cell switch command. Additionally, processor 512 may determine whether an L1-RSRP measurement period is not larger than a predetermined value. Accordingly, processor 512 may determine not to perform a second T/F tracking on the target cell before transmitting a first UL message on the target cell in an event that at least one condition is met. The at least one condition may include that the first T/F tracking on the target cell is activated before the LTM cell switch command and the L1-RSRP measurement period is not larger than the predetermined value.

In some implementations, processor 512 may determine to perform the second T/F tracking on the target cell before transmitting the first UL message on the target cell in an event that at least one condition is met. The at least one condition may include that the first T/F tracking on the target cell is not activated before the LTM cell switch command or the L1-RSRP measurement period is larger than the predetermined value.

In some implementations, the determining of whether the first T/F tracking on the target cell is activated before the LTM cell command may include determining whether a TCI state of the target cell indicated in the LTM cell switch command is in an active TCI state list, and the determining of not to perform the second T/F tracking on the target cell before transmitting the first UL message on the target cell may be performed in an event that at least one condition is met. The at least one condition may include that the target TCI state of the target cell indicated in the LTM cell switch command is in the active TCI state list.

In some implementations, the active TCI state list may include an LTM candidate cell active TCI state list or a serving cell active TCI state list.

In some implementations, processor 512 may receive a MAC CE activating the target TCI state of the target cell.

In some implementations, processor 512 may determine whether a time difference between receiving the MAC CE activating the target TCI state and the LTM cell switch command is at least a duration associated with processing the first T/F tracking and is not larger than the predetermined value, where the determining of not to perform the second T/F tracking on the target cell before transmitting the first UL message on the target cell may be performed in an event that at least one condition is met. The at least one condition may include that the time difference between receiving the MAC CE activating the target TCI state and the LTM cell switch command is at least the duration and is not larger than the predetermined value.

In some implementations, the predetermined value may be 160 ms.

In some implementations, processor 512 may transmit a PRACH preamble to the target cell and receive a RAR from the target cell, where the RAR may include an UL grant for transmitting the first UL message on the target cell.

In some implementations, processor 512 may receive a DCI for scheduling of transmitting the first UL message on the target cell.

In some implementations, the first T/F tracking and the second T/F tracking may include utilizing a RS from the target cell for synchronization with the target cell.

### Illustrative Processes

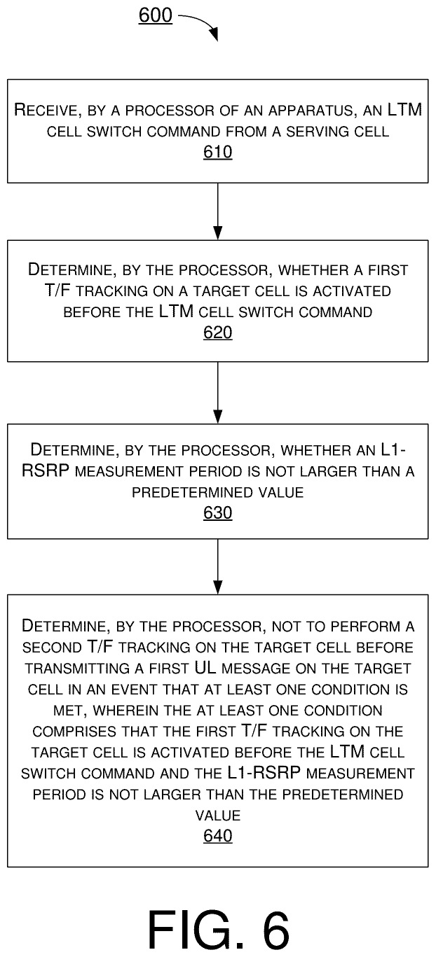

FIG. 6 illustrates an example process 600 in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to reducing a cell switch delay in LTM. Process 600 may include one or more operations, actions, or functions as illustrated by one or more of blocks 610 to 640. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 510 and apparatus 520 as well as any variations thereof. Solely for illustrative purposes and without limiting the scope, process 600 is described below in the context of apparatus 510 as a UE (e.g., UE 230) and apparatus 520 as a communication entity such as a network node (e.g., RUs 210-212) of a wireless network. Process 600 may begin at block 610.

At 610, process 600 may involve processor 512 of an apparatus 510, implemented in or as UE 230, receiving an LTM cell switch command from a serving cell. Process 600 may proceed from 610 to 620.

At 620, process 600 may involve processor 512 determining whether a first T/F tracking on a target cell is activated before the LTM cell switch command. Process 600 may proceed from 620 to 630.

At 630, process 600 may involve processor 512 determining whether an L1-RSRP measurement period is not larger than a predetermined value. Process 600 may proceed from 630 to 640.

At 640, process 600 may involve processor 512 determining not to perform a second T/F tracking on the target cell before transmitting a first UL message on the target cell in an event that at least one condition is met. The at least one condition comprises that the first T/F tracking on the target cell is activated before the LTM cell switch command and the L1-RSRP measurement period is not larger than the predetermined value.

In some implementations, process 600 may further involve processor 512 determining to perform the second T/F tracking on the target cell before transmitting the first UL message on the target cell in an event that at least one condition is met. The at least one condition comprises that the first T/F tracking on the target cell is not activated before the LTM cell switch command or the L1-RSRP measurement period is larger than the predetermined value.

In some implementations, the determining of whether the first T/F tracking on the target cell is activated before the LTM cell command may include determining whether a TCI state of the target cell indicated in the LTM cell switch command is in an active TCI state list, and the determining of not to perform the second T/F tracking on the target cell before transmitting the first UL message on the target cell may be performed in an event that at least one condition is met. The at least one condition may include that the target TCI state of the target cell indicated in the LTM cell switch command is in the active TCI state list.

In some implementations, the active TCI state list may include an LTM candidate cell active TCI state list or a serving cell active TCI state list.

In some implementations, process 600 may further involve processor 512 receiving a MAC CE activating the target TCI state of the target cell.

In some implementations, process 600 may further involve processor 512 determining whether a time difference between receiving the MAC CE activating the target TCI state and the LTM cell switch command is at least a duration associated with processing the first T/F tracking and is not larger than the predetermined value, where the determining of not to perform the second T/F tracking on the target cell before transmitting the first UL message on the target cell may be performed in an event that at least one condition is met. The at least one condition may include that the time difference between receiving the MAC CE activating the target TCI state and the LTM cell switch command is at least the duration and is not larger than the predetermined value.

In some implementations, the predetermined value may be 160 ms.

In some implementations, process 600 may further involve processor 512 transmitting a PRACH preamble to the target cell and receiving a RAR from the target cell, wherein the RAR may include an UL grant for transmitting the first UL message on the target cell.

In some implementations, process 600 may further involve processor 512 receiving a DCI for scheduling of transmitting the first UL message on the target cell.

In some implementations, the first T/F tracking and the second T/F tracking may include utilizing a RS from the target cell for synchronization with the target cell.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a layer 1 (L1) or layer 2 (L2) (L1/L2) triggered mobility (LTM) cell switch command from a serving cell;
determining, by the processor, whether a first time or frequency tracking on a target cell is activated before the LTM cell switch command;
determining, by the processor, whether an L1-reference signal received power (L1-RSRP) measurement period is not larger than a predetermined value; and
determining, by the processor, not to perform a second time or frequency tracking on the target cell before transmitting a first uplink (UL) message on the target cell in an event that at least one condition is met,
wherein the at least one condition comprises that the first time or frequency tracking on the target cell is activated before the LTM cell switch command and the L1-RSRP measurement period is not larger than the predetermined value.

2. The method of claim 1, further comprising:
determining, by the processor, to perform the second time or frequency tracking on the target cell before transmitting the first UL message on the target cell in an event that at least one condition is met,
wherein the at least one condition comprises that the first time or frequency tracking on the target cell is not activated before the LTM cell switch command or the L1-RSRP measurement period is larger than the predetermined value.

3. The method of claim 1, wherein:
the determining of whether the first time or frequency tracking on the target cell is activated before the LTM cell command comprises determining whether a target transmission configuration indicator (TCI) state of the target cell indicated in the LTM cell switch command is in an active TCI state list, and
the determining of not to perform the second time or frequency tracking on the target cell before transmitting the first UL message on the target cell is performed in an event that at least one condition is met,
wherein the at least one condition comprises that the target TCI state of the target cell indicated in the LTM cell switch command is in the active TCI state list.

4. The method of claim 3, wherein the active TCI state list comprises an LTM candidate cell active TCI state list or a serving cell active TCI state list.

5. The method of claim 3, further comprising:
receiving, by the processor, a medium access control (MAC) control element (CE) activating the target TCI state of the target cell.

6. The method of claim 5, further comprising:
determining, by the processor, whether a time difference between receiving the MAC CE activating the target TCI state and the LTM cell switch command is at least a duration associated with processing the first time or frequency tracking and is not larger than the predetermined value,
wherein the determining of not to perform the second time or frequency tracking on the target cell before transmitting the first UL message on the target cell is performed in an event that at least one condition is met,
wherein the at least one condition comprises that the time difference between receiving the MAC CE activating the target TCI state and the LTM cell switch command is at least the duration and is not larger than the predetermined value.

7. The method of claim 1, wherein the predetermined value is 160 milliseconds (ms).

8. The method of claim 1, further comprising:
transmitting, by the processor, a physical random access channel (PRACH) preamble to the target cell; and
receiving, by the processor, a random access response (RAR) from the target cell, wherein the RAR comprises an UL grant for transmitting the first UL message on the target cell.

9. The method of claim 1, further comprising:
receiving, by the processor, a downlink control information (DCI) for scheduling the transmission of the first UL message on the target cell.

10. The method of claim 1, wherein the first time or frequency tracking and the second time or frequency tracking comprises utilizing a reference signal (RS) from the target cell for synchronization with the target cell.

11. An apparatus, comprising:
a transceiver which, during operation, wirelessly communicates with a serving cell and a target cell of a network; and
a processor communicatively coupled to the transceiver such that, during operation, the processor performs operations comprising:
receiving a layer 1 (L1) or layer 2 (L2) (L1/L2) triggered mobility (LTM) cell switch command from the serving cell;
determining whether a first time or frequency tracking on the target cell is activated before the LTM cell switch command;
determining whether an L1-reference signal received power (L1-RSRP) measurement period is not larger than a predetermined value; and
determining not to perform a second time or frequency tracking on the target cell before transmitting a first uplink (UL) message on the target cell in an event that at least one condition is met,
wherein the at least one condition comprises that the first time or frequency tracking on the target cell is activated before the LTM cell switch command and the L1-RSRP measurement period is not larger than the predetermined value.

12. The apparatus of claim 11, wherein, during operation, the processor further performs operations comprising:
determining, by the transceiver, to perform the second time or frequency tracking on the target cell before transmitting the first UL message on the target cell in an event that at least one condition is met,
wherein the at least one condition comprises that the first time or frequency tracking on the target cell is not activated before the LTM cell switch command or the L1-RSRP measurement period is larger than the predetermined value.

13. The apparatus of claim 11, wherein:
the determining of whether the first time or frequency tracking on the target cell is activated before the LTM cell command comprises determining whether a target transmission configuration indicator (TCI) state of the target cell indicated in the LTM cell switch command is in an active TCI state list, and
the determining of not to perform the second time or frequency tracking on the target cell before transmitting the first UL message on the target cell is performed in an event that at least one condition is met,
wherein the at least one condition comprises that the target TCI state of the target cell indicated in the LTM cell switch command is in the active TCI state list.

14. The apparatus of claim 13, wherein the active TCI state list comprises an LTM candidate cell active TCI state list or a serving cell active TCI state list.

15. The apparatus of claim 13, wherein, during operation, the processor further performs operations comprising:
receiving, by the transceiver, a medium access control (MAC) control element (CE) activating the target TCI state of the target cell.

16. The apparatus of claim 15, wherein, during operation, the processor further performs operations comprising:
Determining, by the transceiver, whether a time difference between receiving the MAC CE activating the target TCI state and the LTM cell switch command is at least a duration associated with processing the first time or frequency tracking and is not larger than the predetermined value,
wherein the determining of not to perform the second time or frequency tracking on the target cell before transmitting the first UL message on the target cell is performed in an event that at least one condition is met,
wherein the at least one condition comprises that the time difference between receiving the MAC CE activating the target TCI state and the LTM cell switch command is at least the duration and is not larger than the predetermined value.

17. The apparatus of claim 11, wherein the predetermined value is 160 milliseconds (ms).

18. The apparatus of claim 11, wherein, during operation, the processor further performs operations comprising:
transmitting, by the transceiver, a physical random access channel (PRACH) preamble to the target cell; and
receiving, by the transceiver, a random access response (RAR) from the target cell, wherein the RAR comprises an UL grant for transmitting the first UL message on the target cell.

19. The apparatus of claim 11, wherein, during operation, the processor further performs operations comprising:
receiving, by the transceiver, a downlink control information (DCI) for scheduling of transmitting the first UL transmission on the target cell.

20. The apparatus of claim 11, wherein the first time or frequency tracking and the second time or frequency tracking comprises utilizing a reference signal (RS) from the target cell for synchronization with the target cell.
